(19) United States
(12) Patent Application Publication
(10) Pub. No.: US 2007/0112971 A1
(43) Pub. Date: May 17, 2007

(54) Real time video streaming and data collaboration over wireless networks

(75) Inventors: Jacob Noff, Herzelia (IL); Eliezer Segalowitz, Herzlia (IL); David Dolev-Lipitz, Or Yehuda (IL)

Correspondence Address: DR. MARK FRIEDMAN LTD.;C/O Mr. Bill Polkinghorn, 9003 Florin Way, Upper Marlboro, MD, 20772, US

(73) Assignee: INFODRAW LTD.

(21) Appl. No.: 11/271,876

(22) Filed: Nov. 14, 2005

(51) Int. Cl. G06F 15/16; H04N 7/12; G06K 9/36

(52) U.S. Cl. 709/231; 375/240.26; 709/247; 382/232

(57) ABSTRACT

A method of real time computerized image collaboration of a computerized image stored in memory of transmitting computer. A window is opened which selects a portion of the computerized image and a corresponding portion of memory. Image data stored in the memory portion is compressed and the compressed image data is transferred over a network to a client computer attached to the network. The image portion is visually presented in real time on a client video display attached to the client computer. A user of a client computer requests of the window. Upon receiving control of the window, the controlling user may add metadata by overlaying the image portion or perform other tasks such as move, resize the window and change image parameters. The image portion along with the metadata is shared in real time among other clients.

### FIELD AND BACKGROUND OF THE INVENTION

The present invention relates to wireless networks and specifically to a method for real time video-streaming and data-collaboration in wireless networks.

Command and Control systems (C&C) have focused for a long time on collecting real time information from the field and from multiple distributed sites. However, personnel on the field are required to report and receive updates over a simple radio or other voice channel. Real time information available to the field personnel is limited to voice channels while the command and control center is updated in real time by multiple data sources such as video, map locations etc. This information cannot be conveyed accurately to the field commanders and they are required to complete their mission without receiving full information, such as video, maps, photographs, which exists in the Command and Control center (C&C). The C&C center can be fixed, mobile or even mounted on an air vehicle. The need for real time sharing of information and data-collaboration has become increasingly important, especially for the military and security industries when time to response is critical. Adding meta-data layers over the video layer and sharing this meta-data information with all other users in real-time is essential in many security and military critical applications.

Modern closed circuit television (CCTV) cameras use small high definition color cameras that can not only focus to resolve minute detail, but by linking the control of the cameras to a networked computer, suspicious persons can be tracked semi-automatically. In order to facilitate networking of surveillance cameras, network cameras are commercially available with network interfaces, e.g. TCP/IP over Ethernet. One such camera is AXIS 221. (Axis Communications AB Emdalavägen 14SE-223 69 Lund, Sweden.) Networking multiple surveillance cameras allows controlling the cameras and processing images from all the cameras at a central location, i.e. C&C. Central control is important to allow tracking of suspicious persons that are moving from place to place. Although current surveillance systems enable remote control from a central control center over Internet, there is currently no system or method of annotating images with metadata and sharing of images including the metadata between the CCTV operator near the site of the cameras, a field commander at the C&C and law enforcement personnel in the field.

There is thus a need for, and it would be highly advantageous to have real time video streaming from a personal computer video screen area to handheld computers or cellular phone devices. Furthermore, there is a need to enable an easy on-line markup over the streaming video and remote control application.

Reference: http://en.wikipedia.org/wiki/Closed-circuit_television

### SUMMARY OF THE INVENTION

The term “window” as used herein denotes a portion of an image as visually presented on computer display. The term “image parameters” include as parameters of an image: size, brightness, contrast, color, and zoom.

According to the present invention there is provided a method of real time computerized image and video streaming collaboration of a computerized image stored in memory of transmitting computer. A window is opened which selects a portion of the computerized image and a corresponding portion of memory. Image data stored in the memory portion is captured, compressed and the compressed image data is transferred over a network to one or more client computers attached to the network. The image portion is visually presented in real time on a client video display attached to the client computer. Preferably, control is requested by either a user of the transmitting computer or one of the users of the client computers. Upon receiving control of the image portion, the controller performs tasks such as changing dimensions of the window, changing image parameters of said image portion, moving said window and marking features within said window. Preferably, the image portion is compressed by transforming solely a portion of a frame of the image, the portion being smaller than all macro blocks included in said frame, and the portion includes changed macro blocks within the frame. Preferably, data transfer over the network is limited to a rate less than the streaming image data rate which updates the image portion in real time by a control signal which is sent to reduce the streaming image data rate. Preferably, the data is transferred over a cellular telephone network, and the window has a size corresponding to a display of a cellular telephone.

According to the present invention there is provided a system including a computerized image stored in memory attached to a transmitting computer; a client computer operatively connected to the transmitting computer; and a video collaboration application in which a part runs on the transmitting computer and a another part runs on the client computer. An image portion of the computerized image and a corresponding memory portion of the memory are selected; wherein the application compresses image data stored in the memory portion into compressed image data and transfers the compressed image data to the client computer. A client video display operatively attached to the client computer visually presents in real-time the image portion. Preferably, the application enables a controller to be selected from a user of the transmitting computer or a user of one of the client computers, and the controller opens a window on a visual display of the image, and the window encloses the image portion. Preferably, a user requests control of the image portion and when said the user receives the control, the controller performs tasks such as adding metadata to the mage portion, changing dimensions of the window, changing image parameters of the image portion, moving the window and marking features within the window. Preferably, the application compresses by transforming solely a portion of a frame of the computerized image, wherein the portion includes solely changed macro blocks within the frame. Preferably, the system includes a network which operatively connects the client computer to the transmitting computer, and data transfer over the network is limited to a rate less than a streaming image data rate which updates the image portion in real time; and a feedback mechanism sends a control signal causing the reduction in the streaming image data rate. Preferably, the system includes a video collaboration server connecting the transmitting computer and the client computer, The server transfers the image portion from the transmitting computer to the client computer. Preferably, the server transfers control commands from the client computer to the transmitting computer.

According to the present invention there is provided a program storage device readable by a computer, tangibly embodying a program of instructions executable by the computer to perform a method, as dislosed herein, of real time computerized image collaboration, and a computerized image is stored in memory operatively attached to the computer.

### BRIEF DESCRIPTION OF THE DRAWINGS

The invention is herein described, by way of example only, with reference to the accompanying drawings, wherein:

FIG. 1 illustrates a LAN system architecture, according to an embodiment of the present invention;

FIG. 2 shows a WAN system architecture, according to an embodiment of the present invention;

FIG. 3 is a flow diagram of a method, according to an embodiment of the present invention; and

FIG. 4 illustrates Macro frame compression, a video compression method according to an embodiment of the present invention.

### DESCRIPTION OF THE PREFERRED EMBODIMENTS

The present invention is of a system and method which provides a tool for real time video streaming using video compression algorithms, voice compression and video streaming, data-collaboration, and markup using a meta-data layer over the video layer over wired and wireless IP infrastructure.

Embodiments of the present invention enable the capture of a particular area of a video display, apply video compression and stream the area (in real-time) over a wireless/wired network or over a point-to-point wireless communications link to a remote destination. Very short time-latency is critical and well supported by the invention. The preferred method for video compression method is a novel method based on the H.263 video standard and wavelets compression. Markups (addition of meta-data layers) are performed using a different layer over the streaming video layer.

Embodiments of the present invention provide fast, simple, real-time information sharing, using video compression, audio, and layers for multi-way markup (meta-data) and collaboration. The meta-data can be of any type, such as: graphics, text, picture, audio, image, map etc. The video sampling and the compression are done on the source PC by capturing any part of the screen at for instance 50 Hz. According to an embodiment of the present invention, the compression of each frame is transmitted to a server and then is re-transmitted (unicast or multicast) from the server to specified connected clients. Each authorized PDA/Cellular phone can connect to the server, receive the transmitted information and collaborate with markups over the transmitted information. Remote control can be taken by each one of the connected clients for any application on the PC. The system supports unique and efficient video compression algorithm based on H.263 standard for different information types as video streaming, maps and images. The video compression algorithm, according to an embodiment of the present invention is designed and optimized to operate in the challenging narrow-band environment, and yet to demonstrate high-performance in broadband environment. The preferred communication protocol is based on multicast UDP that gives a number of wireless clients on the same bandwidth. Each new connected mobile client is marked as active with an identifier of the client. Therefore, the transmitter has the knowledge of who is connected and is receiving the streaming data.

According to another embodiment of the present invention, one or more cameras are attached to the computer which functions as both a server and a transmitter computer for the images captured by the cameras.

The principles and operation of the system and method of real time video streaming, and data-collaboration etc., according to the present invention, may be better understood with reference to the drawings and the accompanying description.

By way of introduction, an embodiment of the present invention enables a field commander to receive information such as video streaming, data, images, maps, text, graphics, voice or other critical information in a live stream, together and synchronized with the video layer, from a transmitter a video source such as VGA screen, portable Digital Assistants (PDAs), cellular telephones and/or other portable computers directly to clients, e.g. portable computer or to a portable telephone over wireless, wired and Internet networks. When the information is received such as in the form of an image on a video screen, the present invention may be configured so that either the field commander or control center may take control of the screen and be the controller of the image. The controller of the image “marks up” the screen, defines a specific part of the image, or zooms in, or performs any other action to show specifically the information the controller wishes to convey. Remote control is enabled as well from the portable computer or portable cellular phone to any application running on the server. There is no limit to the number of transmitters within the system. The system supports different information transmitting to different groups of clients at the same time.

It should be noted, that although the discussion herein relates primarily to wireless networks, the present invention may, by non-limiting example, alternatively be configured as well using wired networks.

Further the video compression mechanism may be of any such mechanisms known in the art. While the discussion herein is directed toward application of the present invention to security systems, the principles of the present invention may be readily adapted for use with other non-security related applications such as video conferencing.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

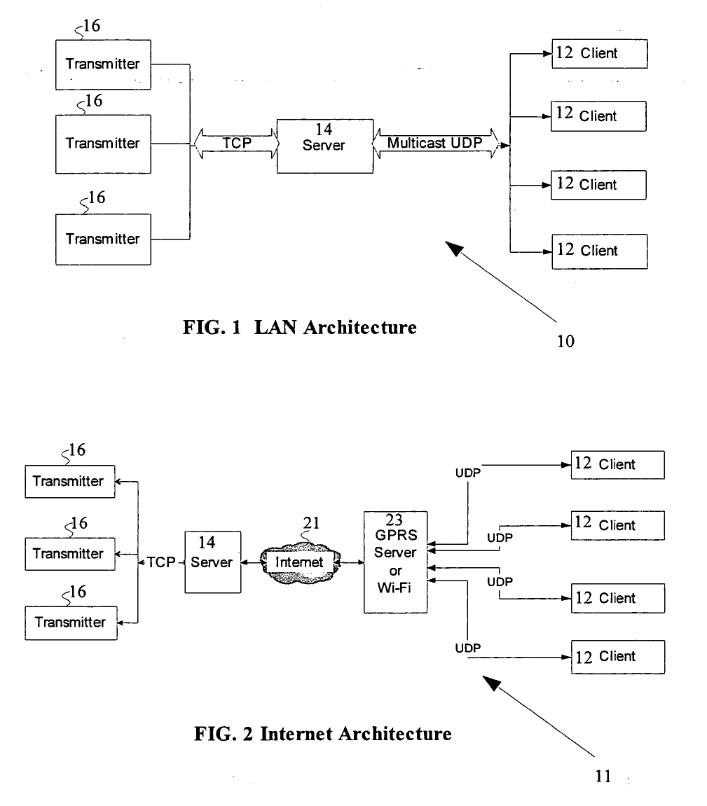

Referring now to the drawings, two system architectures a LAN architecture 10 and a WAN or Internet architecture 11 according to embodiments of the present invention, are shown respectively in FIGS. 1 and 2. LAN architecture 10 is based typically on a wireless LAN, i.e. without an Internet connection nor any connection to any other service provider.

### Wireless LAN Architecture 10

LAN architecture 10 includes typically mobile clients 12, a video or image server 14, and video or image transmitters 16. Image transmitters 16 are typically computerized cameras such as an IP camera which outputs a digital image over TCP/IP protocol or otherwise non-computerized cameras with video outputs input to an external computer. Image transmitters 16 are typically connected to server 14 using a TCP/IP connection. Alternatively, the connections to the cameras are analog video and server 14 functions as transmitter computer 16. According to an embodiment of the present invention, clients 12 in LAN architecture 10 are connected using a specific protocol (e.g. UDP) and receive video streaming from a current transmitter 16. Since transmitter 16 can be one of many transmitters 16, each transmitted message which is stored in client 12 contains a source identifier (e.g. IP address) of transmitter 16 that sourced the message. Every message that client 12 sends, such as a markup, is sent to server 14 with a stored destination identifier (e.g. IP address) to current active transmitter 16. Wireless LAN architecture may be configured using any private network such as point-to-point links, (e.g. LMDS)

### Internet Architecture 11

In Internet architecture 11, server 14 is connected through a WAN 21 typically to a cellular, e.g. GPRS server 23 or access point 23 (e.g. Wi-Fi IEEE 802.11), or a wireless virtual private network (VPN) which connect to mobile clients 12. Video or image server 14 is preferably connected to the Internet 21 through a fast wired connection.

Client 12 (e.g. PDA, portable telephone or portable computer) first connects to video server 14 (using for instance a known IP address of server 14) through a connection (e.g. TCP) created by server 14. The first message contains the client IP address. Video server 14 then creates a connection using a specific protocol (e.g. UDP) with the address of client 12 and begins streaming information from the current active transmitter 16. In the Internet architecture 11, video server 14 creates a separate UDP socket with each connected client 12. Every markup message (e.g. new line, clear line, control command etc) is sent back from client 12 to video server 14. These messages continue to current active transmitter 16 for control functions (e.g. open window, close window, resize window) Other clients 12, if designated, by the active controller or otherwise by server 14 may also receive these messages.

### System Building Blocks

The system includes of three major building blocks:

### Transmitter 16

Transmitter 16 includes a transparent window which can be moved anywhere on an image display or screen. The transmitter window may be resized or hidden. Transmitter 16 activates a video compression algorithm in the image area within the transparent window and compresses the image area according to a selected video compression type. The desired target size is compressed typically to a smaller size compatible with the display of a PDA or portable telephone. For example, if the source size of the transmitter window 16 is a full screen, compression is performed on the information to limit the image to the size of the receiver (e.g. portable telephone). The compression is lossy or lossless depending on the information type (for video streaming it is better to use loss compression). The result is typically sent using TCP protocol with a specific format (e.g. XML) to the queue of video server 14. Transmitter 16 has another transparent layer for markups drawing. Voice messages, for instance can be multicast to all participants using an architecture similar to that used for images.

### Video Server 14

Video server 14 is the center of systems 10 and 11. In wireless LAN architecture 10, video server 14 creates a multicast port, using UDP, for example, and streams all incoming frames to this port at a high data rate (50 megabit per second).

According to an embodiment of the present invention, in Internet architecture 11, over a low bandwidth connection, (e.g. GPRS), server 14 typically uses unicast (e.g. UDP) streaming. When server 14 receives image data from transmitters 16 at a much faster rate, e.g. 50 megabit/sec, the rate of inputting image data from transmitters 16 is critical. A delay between the real time capture of input data at transmitter 16 and the output of image data over a low bandwidth channel will accumulate rendering real-time collaboration problematic. A solution to this problem, is provided with feedback, i.e. a control signal from client 12 to transmitter 16 and/or server 14 which adjusts automatically the rate of data input from transmitter 16 to server 14.

Alternatively, or in addition server 14 can locally store video streaming as disk files with time tags. These files can be multicast at any time, in a similar way as in real time multicast.

### Client 12

Client 12 is for instance a PDA, portable phone or laptop computer and is able to display the streaming video coming from video server 14, and play synchronized sound also coming from server 14. Client 12 has a transparent layer for markups. Each line either added or cleared on the display of client 12 is similarly added or cleared on the current active transmitter 16 and on other connected clients 12. Remote control can be requested of current transmitter 16, if the request is accepted, controlling client 12 is capable to move/resize the transmitter frame, and use the pen/keypad for controlling any application on the PC display. Each client 12 has unique ID that is stored in server 14. The first time client 12 connects the first message contains the client ID. The server checks the ID against known IDs and stores the ID; if the ID exists client 12 is marked as active.

### System Operation and Features

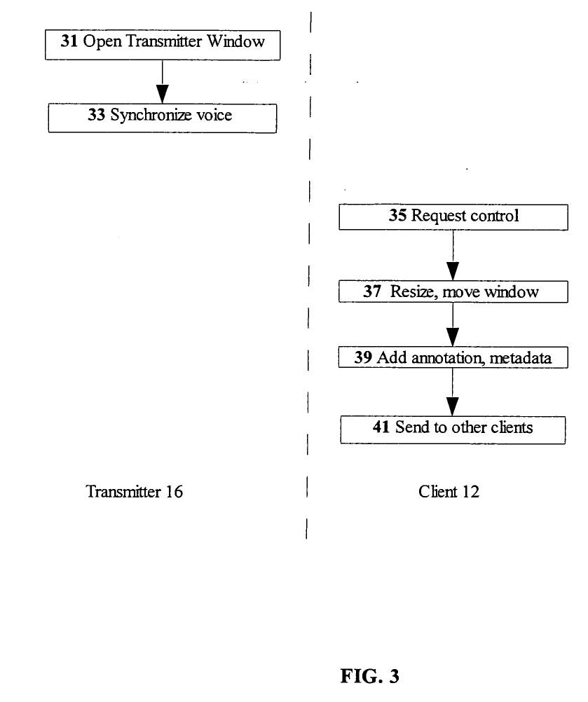

Reference is now made to FIG. 3 which shows a flow diagram of a method, according to an embodiment of the present invention. Sam is a CCTV operator performing security surveillance in shopping center near London. Sam is fortunate to work for a security company with the latest in equipment, although he is concerned that one day he may be displaced by a completely automated security system. Sam noticed on one of his video screens a man hanging around an ATM machine at the bank. With a recent flurry of robberies near ATMs, Sam opens (step 31) a transmitter window 16, according the present invention, on the video screen to include the image of the suspect. Sam opens (step 33) a synchronous voice channel to his field commander at the C&C, Rosie. Sam speaks into a microphone attached to his computer “Rosie, check out this one”. Rosie using a computer as client 12 responds, “I see him” and she requests control (step 35) of transmitter window 16 by selecting from a menu including an identifier of the particular video screen and IP address in use. Rosie resizes and moves the window (step 37) and adds an annotation (step 39) as metadata regarding the location of the camera in use and an arrow pointing to the image of the suspect. In the meantime, as Sam is tracking the suspect on a number of cameras in the shopping mall, Rosie is sending (step 41) the annotated image with the location information as video messages to constables on their portable telephones, clients 12.

Each receiving party at client 12 is able to annotate and mark information over image data being received even over streaming video (using a second layer). These annotations are also viewed back at the Command and Control center (C&C) and all other receiving parties. Each client annotation can be cleared; it is exclusively cleared from all other clients. Still images can be captured (of any size) with markup annotation and sent as images, client 12 can view the images at any time.

System 10,11 maintains information regarding regarding status of all clients 12 connected/disconnected (by name). Voice messages can be sent between all clients An optional module enables the recipients to remote control (step 35) which information they wish to receive and control (any application), without the C&C's intervention. Client 12 can control also the transparent window 16 of the transmitter (resize, move)

The video capture data may be resized from PDA/cellular phone screen size to full screen PC.

According to an embodiment of the present invention, in LAN architecture 10 the information is unicast or alternatively multicast to all mobile clients 12 at the same time. Systems 10, 11 support multiple channels at the same wireless LAN, which means many different transmissions, can be sent to different groups of clients 12 at the same time, one control center can handle many operations each with different information. Systems 10,11 support permission filters which allows each client 12 to participate in a video group only if he is permitted.

### Video Compression

Discrete cosine transform (DCT) is a lossy compression algorithm that samples an image at regular intervals, analyzes the frequency components present in the sample, and discards those frequencies which do not affect the image as the human eye perceives it. DCT is the basis of standards such as JPEG, MPEG and H.263/4 standards.

According to an embodiment of the present invention, the transformed DCT frame is smaller than the sum of all the DCT macro blocks of the same frame. Although, the description herein is based on the H.263 standard, the concept is equally applicable to other compression methods. The compression method, according to an embodiment of the present invention guarantees very low latency while transmitting images.

A macro frame algorithm, according to an embodiment of the present invention summarized as follows:

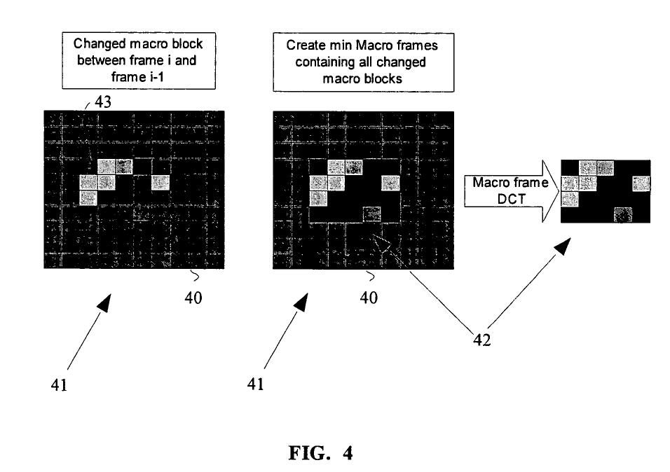

Reference now is made to FIG. 4 which illustrates a compression algorithm, according to an embodiment of the present invention.

Encoder

Each frame 41 is divided to 8×8 or 16×16 or 32×32 macro blocks 40. Each macro block 40 is checked against the same macro block 40 from the previous frame 41 for the changes. Each changed macro block 43 is marked. An algorithm is applied to build a minimum size macro frame 42 containing the changed macro blocks 43. The unchanged macro blocks 40 within macro frame 41 are changed to one color (e.g. black) to reduce the amount of information. Each changed macro block 43 in macro frame 42 is indexed. The encoding process continues by building a new DCT of the changed macro frame 42, and building a bit stream with Macro frames information.

Decoder

Macro frames 42 are extracted from the bit stream. For each macro frame 42 each changed macro block 43 from macro frame 42 is extracted and placed in the correct position of macro block 43 of the current frame 41.

In other embodiments of the present invention, a similar algorithm is also applied for lossless compression using PNG/GIF algorithm instead of DCT algorithm.

### System Development

The preferred system software is based on MS NET and the mobile clients are based on MS .NET CF.

According to an additional embodiment of the present invention, remote control is achieved from a mobile client. Remote control is useful for applications, as follows:
Control PC application from PDA or Cell phone.
Receive video alert using video motion detector (VMD) inside the transmitter.
Receive real time video updates from public sites (Intersections, roads etc.)

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

What is claimed is:

1. A method of real time computerized image collaboration, comprising the steps of:
(a) providing a computerized image stored in memory operatively attached to a transmitting computer;
(b) opening a window thereby selecting an image portion of said image, and a corresponding memory portion of said memory;
(c) compressing image data stored in said memory portion into compressed image data;
(d) transferring said compressed image data over at least one network to a client computer, wherein said transmitting computer and said client computer are operatively attached through said at least one network; and
(e) visually presenting in real-time said image portion on a client video display attached to said client computer.

2. The method, according to claim 1, further comprising the steps of:
(f) requesting control of said image portion by one controller selected from the group of users consisting of a user of said transmitting computer and a user of said client computer.
(g) upon said controller receiving control of said image portion, performing at least one task selected from the group of tasks consisting of adding metadata to said image portion, changing dimensions of said window, changing image parameters of said image portion, moving said window and marking features within said window.

3. The method, according to claim 1, wherein said compressing includes transforming solely a portion of a frame of said image, said portion being smaller than all macro blocks included in said frame, wherein said portion includes changed macro blocks within said frame.

4. The method, according to claim 1, wherein said transferring over said at least one network is limited to a rate of data transfer less than a streaming image data rate which updates said image portion in real time, further comprising the step of:
(f) sending a control signal thereby reducing said streaming image data rate

5. The method, according to claim 1, wherein said at least one network is a cellular telephone network, wherein said window has size corresponding to a display of a cellular telephone.

6. A system comprising:
(a) a computerized image stored in memory attached to a transmitting computer;
(b) a client computer operatively connected to said transmitting computer;
(c) a video collaboration application wherein a first portion of said application runs on said transmitting computer and a second portion of said application runs on said client computer, wherein an image portion of said computerized image and a corresponding memory portion of said memory are selected; wherein said application compresses image data stored in said memory portion into compressed image data and transfers said compressed image data to said client computer; and
(d) a client video display operatively attached to said client computer which visually presents in real-time said image portion.

7. The system, according to claim 6, wherein said application enables a controller to be selected from the group of users consisting of a user of said transmitting computer or a user of said client computer, wherein said controller opens a window on a visual display of said image, wherein said window encloses said image portion.

8. The system, according to claim 7, wherein one of said users requests control of said image portion and when one user receives said control, said controller performs at least one task selected from the group of tasks consisting of adding metadata to said image portion, changing dimensions of said window, changing image parameters of said image portion, moving said window and marking features within said window.

9. The system, according to claim 6, wherein said application compresses by transforming solely a portion of a frame of said computerized image, wherein said portion includes solely changed macro blocks within said frame.

10. The system, according to claim 6, further comprising:
(d) at least one network which operatively connects said client computer to said transmitting computer, wherein data transfer over said at least one network is limited to a rate less than a streaming image data rate which updates said image portion in real time; and
(f) a feedback mechanism which sends a control signal causing a reduction in said streaming image data rate.

11. The system, according to claim 6, further comprising:
(f) a video collaboration server operatively connecting said transmitting computer and said client computer, said server transferring said image portion from said transmitting computer to said client computer.

12. The system, according to claim 11, wherein said server further transfers control commands from said client computer to said transmitting computer.

13. A program storage device readable by a computer, tangibly embodying a program of instructions executable by the computer to perform a method of real time computerized image collaboration, wherein a computerized image is stored in memory operatively attached to the computer, the method comprising the steps of:
(a) opening a window thereby selecting an image portion of said image, and a corresponding memory portion of the memory;
(b) compressing image data stored in said memory portion into compressed image data; and
(c) transferring said compressed image data over at least one network to a client computer, wherein said transmitting computer and said client computer are operatively attached through said at least one network; and
(d) visually presenting in real-time said image portion on a client video display attached to said client computer.
